(19) United States
(12) Patent Application Publication
(10) Pub. No.: US 2009/0243993 A1
(43) Pub. Date: Oct. 1, 2009

(54) LIQUID-CRYSTAL PANEL, LIQUID-CRYSTAL DISPLAY DEVICE, AND PORTABLE TERMINAL

(75) Inventor: Hideki Kuga, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/295,708

(22) PCT Filed: Oct. 24, 2006
(86) PCT No.: PCT/JP2006/321167

§ 371 Date: Oct. 1, 2008

(51) Int. Cl. G09G 3/36; G02F 1/133

(52) U.S. Cl. 345/102; 349/116

(57) ABSTRACT

To provide a liquid-crystal display device that can be miniaturized while optimum brightness is ensured, as well as a portable terminal using the liquid-crystal display device.

In a liquid-crystal display device, a first sensor 7 is situated on a metallic wiring layer 35; blocks light from a backlight 5; is placed in an open area which is not covered with a black matrix 21 with respect to external light; and detects incident external light. A second sensor 8 is placed at a position other than location of the metallic wiring layer, and detects light from the backlight. A control section 103 adjusts the brightness of the backlight 5 in accordance with the intensity of external light detected by the first optical sensor 7 and the brightness of the backlight detected by the second optical sensor 8.

### TECHNICAL FIELD

The present invention relates to a liquid-crystal display device using a special liquid-crystal panel; and more particularly to a liquid-crystal display device for optimally adjusting the brightness of backlight provided on the back of the liquid-crystal panel by means of an optical sensor, as well as to a portable terminal using the liquid-crystal display device.

### BACKGROUND ART

In general, a liquid-crystal display device has widely been used as an image display device such as a portable terminal. With a view toward enhancing the power of expression of a display image, an increase in the number of pixels of a liquid-crystal panel of the liquid-crystal display device of this type and miniaturization of pixels have recently been made.

In association with an increase in the number of pixels and miniaturization of pixels, the transmissivity of the liquid-crystal panel of the liquid-crystal display device decreases, and hence the brightness of backlight that is a light source located on the back of the liquid-crystal panel must be increased further.

However, in a liquid-crystal display device having related-art backlight, a user must perform laborious operation by himself/herself; that is, actuation of an operation section of the liquid-crystal display device, to thus change the brightness level of backlight according to the level of external light achieved at a location where the device is used. Even when the brightness of a display screen is sufficient, there may arise a case where backlight is illuminated unnecessarily, which poses a problem of an increase in power consumption.

In order to solve this problem, a liquid-crystal display device is described in, e.g., JP-A-2002-131719. In this liquid-crystal display device, light or darkness of external light achieved in a usage environment of the liquid-crystal display device is detected, and actuation/deactivation of backlight is controlled in accordance with a result of detection. This obviates the necessity for the user of the liquid-crystal display device equipped with backlight performing laborious operation, such as illumination or extinction of backlight according to the level of light or darkness of the external light achieved at the use location. Further, exhaustion of the battery is prevented, to thus enable an attempt to the life of the battery long.

Moreover, JP-A-9-172664 describes a display-equipped individual, selective calling receiver having an LCD (Liquid-Crystal Display: a display section). In this display-equipped individual, selective calling receiver, an optical sensor section detects the amount of light received by the LCD, and a control section controls the intensity of illumination of the LCD and whether to illuminate a backlight unit according to the detected amount of received light.

### DISCLOSURE OF THE INVENTION

### Problem that the Invention is to Solve

However, a space for mounting an optical sensor element needs to be ensured in the related-art liquid-crystal display device, which in turn leads to an increase in cost. Further, when a window for use with an optical sensor is opened, a design characteristic of the device is impaired. Moreover, when an optical sensor element is provided at a position other than the surface of the display, it may be the case that external light incident upon the display surface cannot be detected properly. There is also a problem of a structure becoming complicate as a result of consideration being given to a location where an optical sensor is to be mounted.

The present invention has been conceived to solve the problem of the related art and aims at providing a liquid-crystal panel, a liquid-crystal display device, and a portable terminal, wherein a first sensor for detecting external light and a second sensor for detecting the brightness of backlight are provided in a liquid-crystal panel; especially, on a glass substrate of the liquid-crystal panel, and wherein the device can be miniaturized while optimum brightness is ensured.

### Means for Solving the Problem

A liquid-crystal display device of the present invention includes a backlight;

a liquid-crystal panel provided on the backlight;

a first optical sensor for detecting external light and a second optical sensor for detecting brightness of the backlight which are provided in a plane of a glass substrate of the liquid-crystal panel; and

a control section for adjusting brightness of a light source of the backlight in accordance with intensity of external light detected by the first optical sensor and brightness of the backlight detected by the second optical sensor.

By means of this configuration, optimum brightness can be ensured by arranging the first sensor for detecting external light and the second sensor for detecting the brightness of a backlight. Further, a space used for mounting a sensor element is obviated, thereby preventing an increase in cost.

Although the first optical sensor can be disposed in a display area where pixels of the liquid-crystal panel exist, the first optical sensor is preferably disposed at a position within a plane of the glass substrate spaced a predetermined distance away from a perimeter of the glass substrate.

By means of this configuration, external light can be detected more accurately. Especially, the influence of a shade cast by a frame, or the like, to which the liquid-crystal panel is attached (influence imposed particularly by incidence of oblique light) can be prevented, by means of disposing the first optical sensor at a position spaced a predetermined distance or more away from a perimeter of the glass substrate.

Further, the first optical sensor can be positioned in an area in the plane of the liquid-crystal panel where a metallic wiring layer exists and on a side on which external light is incident when viewed from the metallic wiring layer. By means of this configuration, the first optical sensor can be attached readily and can correctly detect external light without being affected by the backlight.

The second optical sensor can be positioned in an area in the plane of the liquid-crystal panel where a black matrix exists and on the backlight side when viewed from the black matrix. Here, the first optical sensor can be disposed at an area within a plane of the liquid-crystal panel where the black matrix does not exist. By means of this configuration, the second optical sensor can be attached readily and can correctly detect the brightness of a backlight without being affected by the backlight.

Moreover, in the liquid-crystal display device of the present invention, each of the first optical sensor and the second optical sensor is provided in numbers.

By means of this configuration, a decrease in the accuracy of the backlight, which would otherwise be caused by variations in in-plane brightness of illumination (i.e., variations in illumination brightness), can be prevented.

The liquid-crystal display device of the present invention further includes a storage device for storing the brightness of the backlight previously set as a default value in response to the intensity of external light, wherein the control section increases the brightness of the light source of the backlight when current brightness of the backlight is smaller than the default value responsive to predetermined intensity of external light. Meanwhile, the control section decreases the brightness of the light source of the backlight when current brightness of the backlight is greater than the default value responsive to predetermined intensity of external light.

When the brightness of the backlight is smaller or greater than the default value, optical brightness can be ensured by means of this configuration.

The liquid-crystal display device of the present invention further comprises a storage device for storing the brightness of the backlight previously set as a default value in response to the intensity of external light; and an input section by means of which a user performs operation for changing backlight brightness of the backlight, wherein the control section sets the brightness of the light source in response to another value of backlight brightness when the brightness of the backlight has been changed, by means of the input section, to the other value from the default value responsive to the predetermined intensity of external light. In this configuration, it may be the case where the control section sets a new default value over the entire intensity range of external light in accordance with the other value.

By means of this configuration, optimum backlight brightness meeting the user's preference can be obtained.

The above-described liquid-crystal display device can be applied to a portable terminal. In this case, a display section of a portable cellular phone can also ensure optimum brightness.

The present invention also provides a liquid-crystal panel including:

a first glass substrate disposed at a side on which external light is incident;

a second glass substrate disposed at a side away from the side on which external light is incident, with respect to the first glass substrate;

a liquid-crystal layer sealed between the first glass substrate and the second glass substrate;

a first optical sensor which is disposed on either the first glass substrate or the second glass substrate for detecting external light; and

a second optical sensor which is disposed on either the first glass substrate or the second glass substrate for detecting brightness of a backlight, wherein

the first optical sensor is disposed on a first shield which blocks light from the backlight; and

the second optical sensor is disposed on a second shield which blocks external light. A liquid-crystal display device and a portable terminal which enable realization of appropriate backlight brightness can be provided by use of this liquid-crystal panel.

### ADVANTAGE OF THE INVENTION

The present invention provides a liquid-crystal panel, a liquid-crystal display device, and a portable terminal, wherein a first sensor for detecting external light and a second sensor for detecting the brightness of backlight are provided in a liquid-crystal panel; especially, on a glass substrate of the liquid-crystal panel, and wherein the device can be miniaturized while optimum brightness is ensured.

### BRIEF DESCRIPTION OF THE DRAWINGS

FIG. 1 is a view showing a common TFT liquid-crystal module.

FIG. 2 is a view showing a cross section of the common TFT liquid-crystal module.

FIG. 3 is a view showing a cross section of the common TFT liquid-crystal module.

FIG. 4 is a view showing a common liquid-crystal display device.

FIG. 5 is a view showing the configuration of a liquid-crystal display device of an embodiment of the present invention.

FIG. 6 is a view showing a position in the TFT where a first sensor and a second sensor are disposed and a position in the same where wiring is laid.

FIG. 7 is an enlarged view of Section A corresponding to the position where the first sensor and the second sensor are provided.

FIG. 8 is an enlarged view of Section B corresponding to the position where wiring is routed.

FIG. 9 is a view showing an example modification to the position where wiring is routed.

FIG. 10 is a block diagram of the entirety of a portable terminal including the liquid-crystal display device of the present invention, particularly, the entirety of a portable cellular phone.

FIG. 11 is a view showing an example backlight control section/booster section.

FIG. 12 is a view showing another example backlight control section/booster section.

FIG. 13 is a view showing the illumination brightness of backlight and a drive current for backlight LEDs responsive to the amount of light detected by the first sensor.

FIG. 14 is a view showing an example where a correction is made to increase the drive current for the backlight LEDs when the brightness of backlight is lower than an optimum backlight brightness value when compared with the intensity of external light.

FIG. 15 is a flowchart showing operation for making a correction and increasing the drive current for the backlight LEDs shown in FIG. 14.

FIG. 16 is a view showing changes in the drive current for the backlight LEDs in response to variations in the illumination brightness of backlight.

FIG. 17 is a view showing an example where, when the user has changed settings of brightness of backlight from Pn to Pna while the intensity of external light is Ltn, IBLna responsive to backlight brightness Pna is caused to flow as a drive current for the backlight LEDs, thereby illuminating the LEDs.

FIG. 18 is a flowchart showing correction operation performed when the user has changed the settings.

FIG. 19 is a view showing an example where the user has changed settings of brightness of backlight from Pn to Pna while the intensity of external light is Ltn and subsequently further changed to Pnb the illumination brightness of backlight achieved while the intensity of the external light is Ltnb, thereby causing IBLnb to flow as a drive current for the backlight LEDs responsive to the brightness Pnb of backlight and illuminating the LEDs.

FIG. 20 is a view showing an example where a first optical sensor 7 and a second optical sensor 8 are provided respectively in numbers.

### DESCRIPTIONS OF THE REFERENCE NUMERALS

1 TFT LIQUID-CRYSTAL MODULE
2 TFT LIQUID-CRYSTAL PANEL
3 DRIVE CIRCUIT
4 LIQUID-CRYSTAL DISPLAY DEVICE
5 BACKLIGHT
7 FIRST SENSOR
8 SECOND SENSOR
21 BLACK MATRIX (BLACK MASK)
22 POLARIZING PLATE
23, 24 GLASS SUBSTRATES
25 COLOR FILTER
26 TFT (THIN-FILM TRANSISTOR)
27 PROTECTIVE FILM
28a TRANSPARENT ELECTRODE (COMMON ELECTRODE)
28b TRANSPARENT ELECTRODE (DISPLAY ELECTRODE)
29 ORIENTATION FILM
30 LIQUID-CRYSTAL
31 LIQUID-CRYSTAL DRIVER
32 FLEXIBLE SUBSTRATE
330N-GLASS CONNECTION TERMINAL
34 CONTROL-SYSTEM CONNECTION TERMINAL
35 METALLIC WIRING LAYER
100 PORTABLE TERMINAL
101 POWER SECTION
102 BATTERY
103 CONTROL SECTION
104 RADIO SECTION
105 DISPLAY CONTROL SECTION
107 BACKLIGHT CONTROL SECTION (BOOSTER SECTION)
109 CLOCK CONTROL SECTION
110 SOUND PROCESSING SECTION
111 SPEAKER
112 MICROPHONE
113 KEY INPUT SECTION
114 STORAGE DEVICE

### BEST MODE FOR IMPLEMENTING THE INVENTION

A liquid-crystal panel and a liquid-crystal display device of an embodiment of the present invention will be hereinafter described by reference to the drawings.

Common TFT liquid crystal is first described before explanation of the embodiment of the present invention.

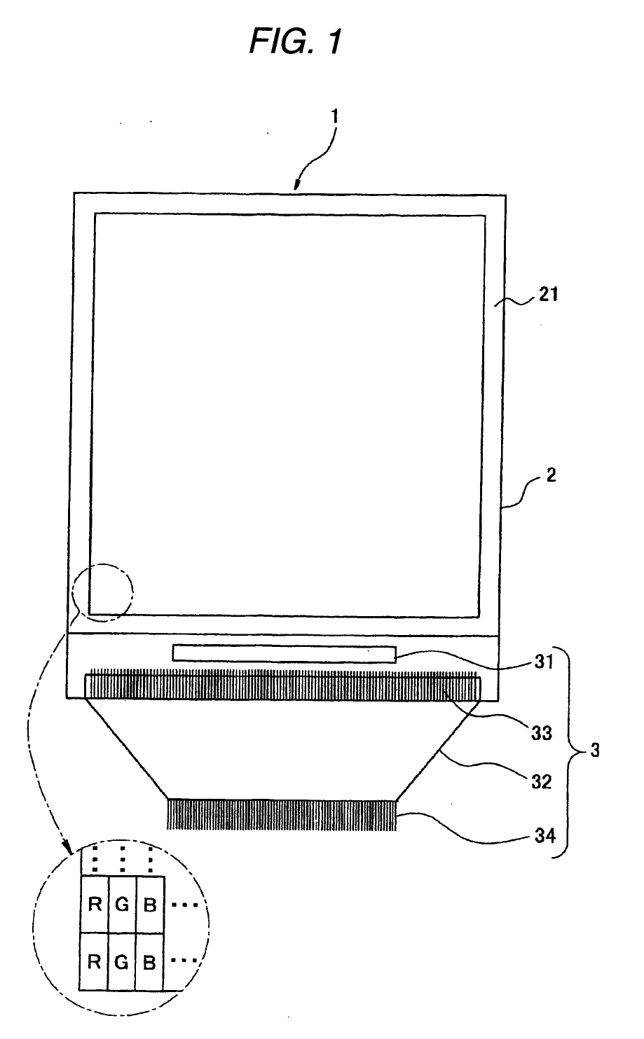

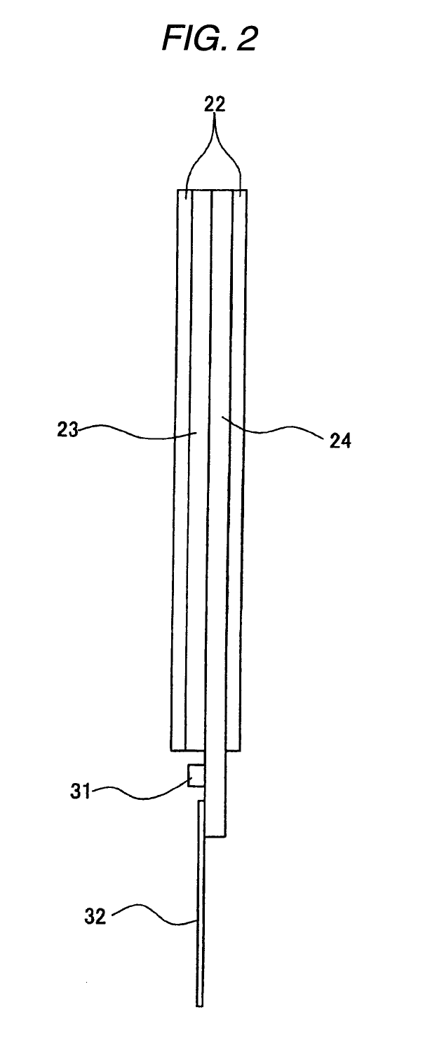

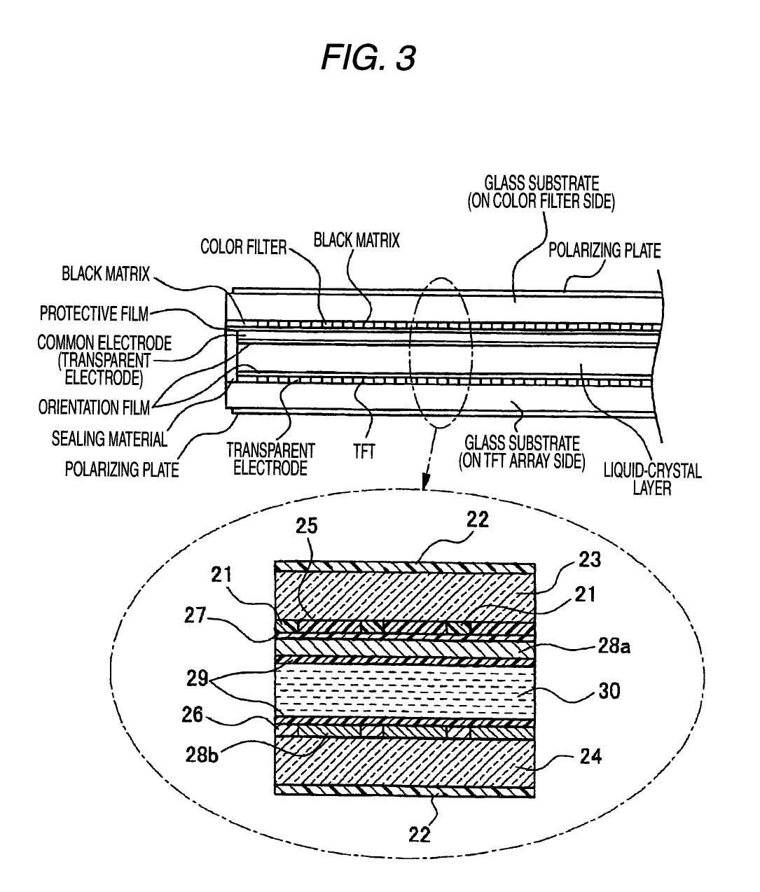

FIG. 1 is a view showing a TFT liquid-crystal module constituting a liquid-crystal display device; FIG. 2 is a view showing a cross section (side surface) of a common TFT liquid-crystal module; and FIG. 3 is a view showing a cross section of common TFT liquid crystal.

As shown in FIGS. 1 and 2, a TFT liquid-crystal module 1 is formed from a TFT liquid-crystal panel 2 and a drive circuit 3. A display area of the TFT liquid-crystal panel 2 is formed by means of arrangement of RGB color filters. A space between pixels and the perimeter of the display area are covered with a black matrix 21. The TFT liquid-crystal panel 2 has two polarizing plates 22 disposed on the outside of the panel and two mutually-opposing glass substrates; namely, a first glass substrate (a color-filter-side glass substrate) 23 and a second glass substrate (a TFT-array-side glass substrate) 24.

The drive circuit 3 comprises a liquid-crystal driver 31 for driving TFT liquid crystal applied over the second glass substrate 24 among the above-described two glass substrates; a flexible substrate 32 connected to the second glass substrate 24; an on-glass connection terminal 33 which is a peripheral component of a liquid-crystal driver 31 mounted on the flexible substrate; and a control-system connection terminal 34 for establishing interface connection with a control side.

FIG. 3 is a view showing a cross section of common TFT liquid crystal.

The TFT liquid-crystal panel 2 has the two polarizing plates 22 disposed on the outside of the panel; the mutually-opposing two glass substrates 23 and 24; a color filter 25; a TFT (Thin-Film Transistor) 26; a protective film 27; a transparent electrode (common electrode) 28a, a transparent electrode (display electrode) 28b, an orientation film 29, a black matrix (black mask) 21, and a liquid-crystal layer 30.

The polarizing plate 22 is for allowing transmission of a specific polarizing component or absorbing the same. The glass substrates 23 and 24 are transparent substrates and are generally made of non-alkali glass exhibiting superior flatness. The color filter 25 is formed from a resin film having the three primary colors of Red, Green, Blue (RGB) and is impregnated with a dye or a pigment and is for creating various colors (a color display) by means of mixture of the three primary colors.

The TFT 26 constitutes a switching element for driving liquid crystal and is formed from a transparent electrode and metal wiring. The TFT 26 is placed at respective points of intersection of a gate line arranged on the panel in a matrix pattern and a data line. By means of application of a pulse voltage (a scan signal) to the gate line and application of a signal voltage from the data line, the TFT 26 acts as a switching element, thereby controlling a voltage applied to pixels.

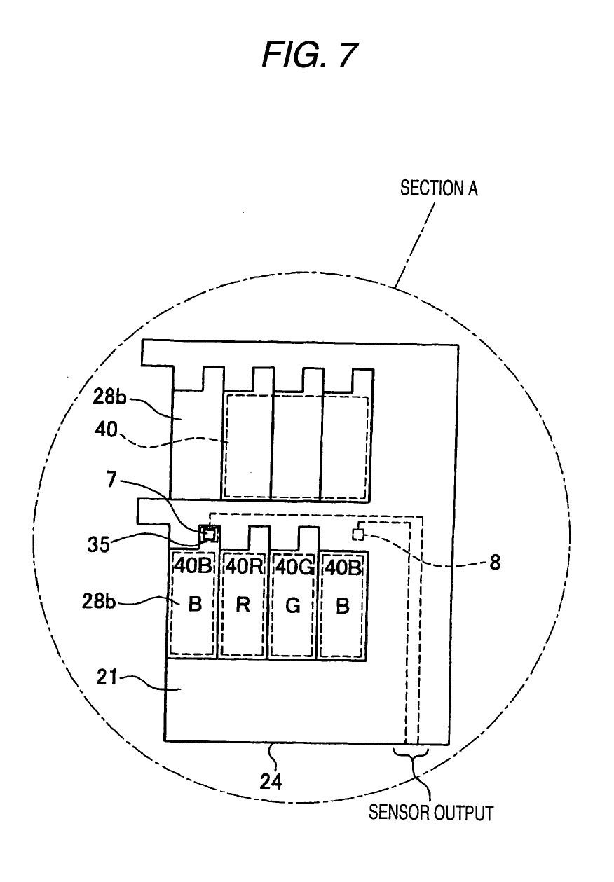

The protective film 27 is a resin film for protecting the color filter 25. The transparent electrodes 28a and 28b are generally formed from an ITO (Indium Tin Oxide) transparent conductive thin film. The transparent electrode 28a close to the glass substrate 23 is a so-called common electrode and uniformly formed over the entire panel. Meanwhile, the transparent electrode 28b close to the glass substrate 24 is a so-called display electrode and separately formed for each of pixels (particularly for each of RGB sub-pixels: see FIG. 7).

The orientation film 29 is an organic thin film for orienting liquid crystal formed from a polyimide thin film or the like. The black matrix (black mask) 21 is a light-shielding film placed around the color filters and between the pixels. The liquid-crystal layer 30 is sealed between the first glass substrate (the color-filter-side glass substrate) 23 and the second glass substrate (a TFT-array-side glass substrate) 24.

For instance, a non-display area other than the display area where an image is actually displayed is usually provided with masking in order to prevent leakage of backlight. This masking is achieved by means of a black matrix arranged along the perimeter of the panel.

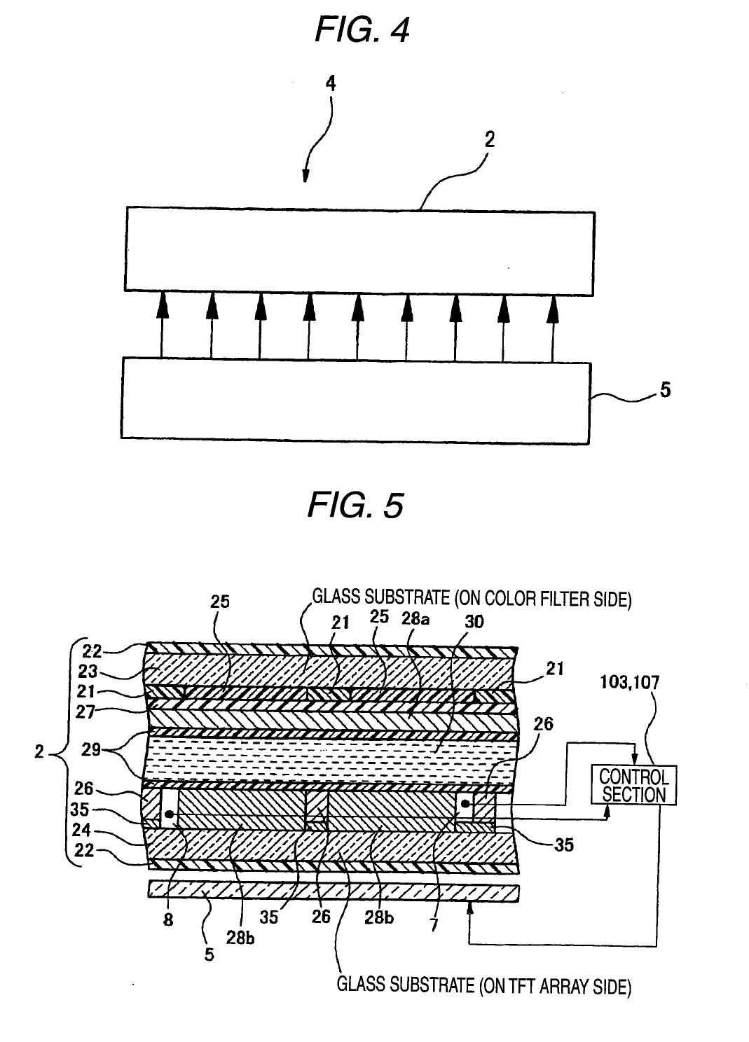

FIG. 4 is a view showing a common liquid-crystal display device. In FIG. 4, a liquid-crystal display device 4 has the TFT liquid-crystal panel 2 shown in FIGS. 1 through 3 and backlight 5 for emitting light from the back of the panel toward the TFT liquid-crystal panel 2.

In a state where the TFT liquid-crystal panel 2 remains illuminated by white light originating from the backlight 5, a desired full color video display is obtained.

FIG. 5 is a view showing the configuration of a liquid-crystal display device of the embodiment of the present invention.

In addition to including the configuration of the common liquid-crystal display device, the liquid-crystal display device of the present invention has a first sensor (a sensor for detecting the intensity of external light) 7 and a second sensor (a sensor for detecting the brightness of backlight) 8 which are provided in the liquid-crystal panel of the device. The first sensor 7 and the second sensor 8 are placed, within the TFT liquid-crystal panel 2 of each of embodiments, particularly at an area—through which light (external light or light from the backlight) passes—in a plane of the glass substrate.

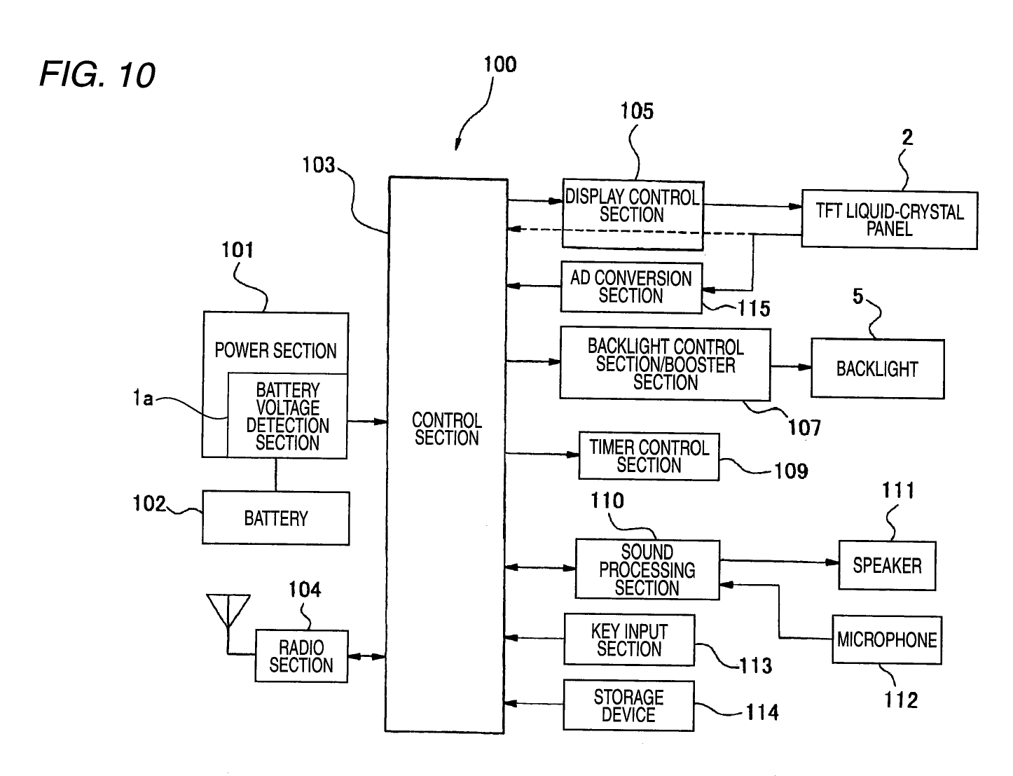

An output of the first sensor 7 and an output of the second sensor 8 are withdrawn by means of wiring. Wiring is withdrawn to a connection terminal and is output to a control-system connection terminal 34 through a flexible substrate 32. The control-system connection terminal 34 further leads the output of the first sensor 7 and the output of the second sensor 8 to control sections 103 and 107 (see FIG. 10), respectively. The control sections 103 and 107 adjust an electric current for the backlight in accordance with the intensity of the external light detected by the first optical sensor 7 and the brightness of the backlight detected by the second optical sensor 8.

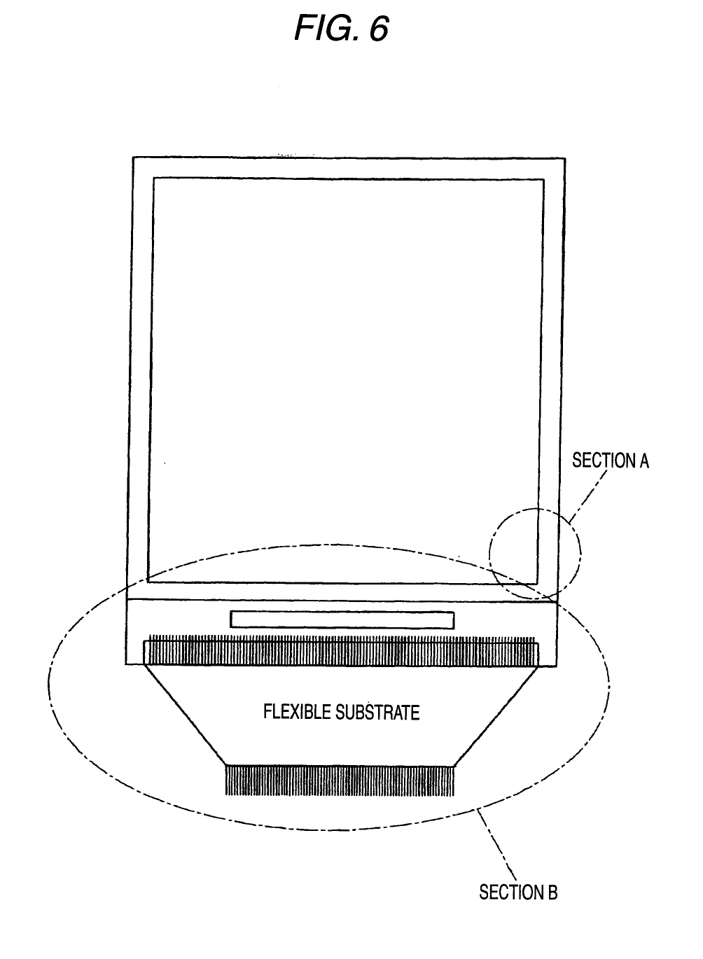

FIG. 6 is a view showing the position in the TFT liquid-crystal module 1 where the first sensor 7 and the second sensor 8 are disposed and the position in the same where wiring is routed. In FIG. 6, reference symbol Section A designates the position where the first sensor 7 and the second sensor 8 are disposed, and reference symbol Section B designates the position where wiring is routed.

FIG. 7 is an enlarged view of Section A corresponding to the position where the first sensor 7 and the second sensor 8 are disposed. The first sensor 7 is disposed on an upper surface (a surface through which external light enters) of the second glass substrate 24 (see FIG. 5). The position of the first sensor 7 within the plane of the glass substrate 24 is immediately above (a point where external light enters when viewed from a metallic wiring layer) the metallic wiring layer 35 connected to the transparent electrode 28b and corresponds to an open area in an upper side of the metallic wiring layer that is not covered with the black matrix 21. Since the metallic wiring layer 35 is for blocking light of the backlight 5 incident from the lower side, the first sensor 7 can detect only the external light incident from the outside. Here, it may also be the case that the metallic wiring layer 35 includes an area—by way of which an electric current is supplied to the respective pixels of the TFT liquid-crystal panel 2—and a remaining area (an area where an electric current is not supplied) other than that area and is formed on any of the areas.

The second sensor 8 is also disposed on the upper surface (the surface through which external light enters) of the second glass substrate 24 (see FIG. 5). The position of the second sensor 8 within the plane of the glass substrate 23 is immediately below an area where the black matrix 21 is arranged (an area close to the backlight when viewed from the black matrix) and corresponds to a location spaced apart from the metallic wiring layer 35. The second sensor 8 is covered with the black matrix 21 with respect to the external light and, hence, can detect only light from the backlight.

The position of the first sensor 7 and the position of the second sensor 8 are not limited to those shown in FIGS. 5 and 7. The essential requirement is that the first sensor 7 and the second sensor 8 be disposed at a position where the sensor 7 can detect external light without being affected by the influence of the backlight and where the second sensor 8 can detect light from the backlight without being affected by the influence of external light. Specifically, it is better to place the first optical sensor 7 on a first light-shielding substance that blocks light from the backlight and to place the second optical sensor 8 on a second light-shielding substance that blocks external light.

For instance, the first sensor 7 can be disposed at a position in the first glass substrate 23 immediately above the black matrix 21. The second sensor 8 can be disposed at a position in the first glass substrate 23 immediately below the black matrix 21. In the example shown in FIG. 5, the metallic wiring layer 35 may also be formed on the second optical sensor 8, to thus protect the second optical sensor 8 from external light.

Further, no limitations are particularly imposed on the position of the first optical sensor 7 within the plane of the glass substrate. However, it is desirable to place the first optical sensor 7 in a so-called display area (an area where an image is actually displayed) where the pixels of the TFT liquid crystal panel 2 exist (see FIG. 7). Specifically, the reason for this is that ensuring visibility in the display area and measuring the intensity of external light falling on this area are important. Moreover, it is preferable to place the first optical sensor 7 at a position within the plane of the glass substrate spaced a predetermined distance or more from the perimeter of each of the glass substrates 23 and 24. An obstacle, such as an attachment frame of a liquid-crystal panel, exists in the perimeter of the glass substrate, and the obstacle is likely to cast a shade at the time of entrance of, especially, oblique light. There may arise the case where the difficulty is encountered in accurately detecting the intensity of external light in an area spaced a predetermined distance from the frame. Accordingly, the first optical sensor is disposed at a position spaced a predetermined distance or more from the perimeter of the glass substrate so as to prevent casting of such a shade. Thereby, the intensity of external light can be detected accurately while the influence of a shade is suppressed.

In FIG. 7, one pixel 40 includes three sub-pixels 40R (red), 40G (green), and 40B (blue). The sub-pixels are defined by means of transparent electrodes (display electrodes) 28b on the second glass substrate 24 partitioned into respective sub-pixels and segments of the color filter 25 having any pixels of red, green, and blue colors. The TFT 26 serving as a switching element activates or deactivates each of the sub-pixels. In the present embodiment, the first sensor 7 is disposed on the metallic wiring layer 35 connected to the transparent electrode 28b of the sub-pixel 40B.

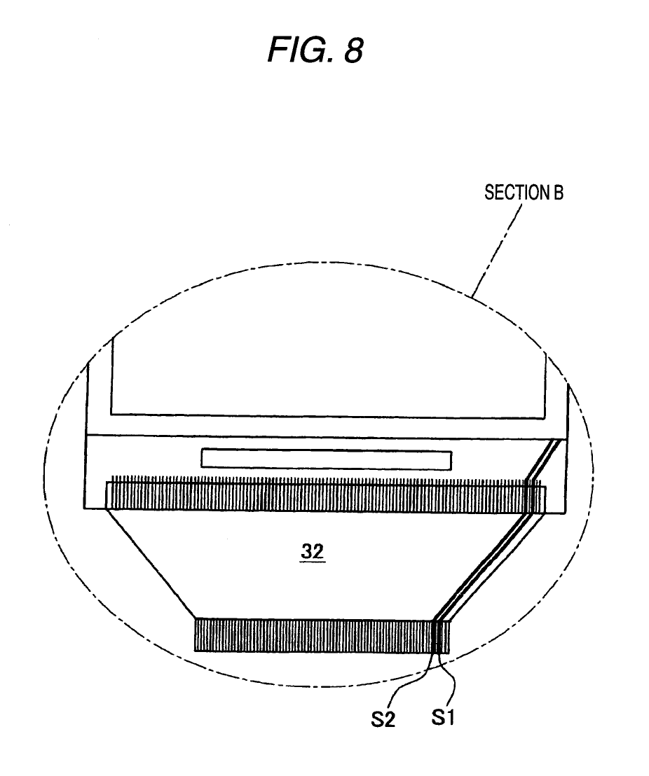

FIG. 8 is an enlarged view of Section B serving as the position where wiring is routed. Wiring is withdrawn to the connection terminal and output through the flexible substrate 32 to the control-system connection terminal 34 on the flexible substrate. A detection signal (a first detection signal) S1 from the first sensor 7 and a detection signal (a second detection signal) S2 from the second sensor 8 are output by way of this wiring. The signal output from the first sensor 7 and the signal output from the second sensor 8 are converted into digital signals by means of an unillustrated AD (analog-to-digital) conversion section disposed outside, and the digital signals are output to the control section 9.

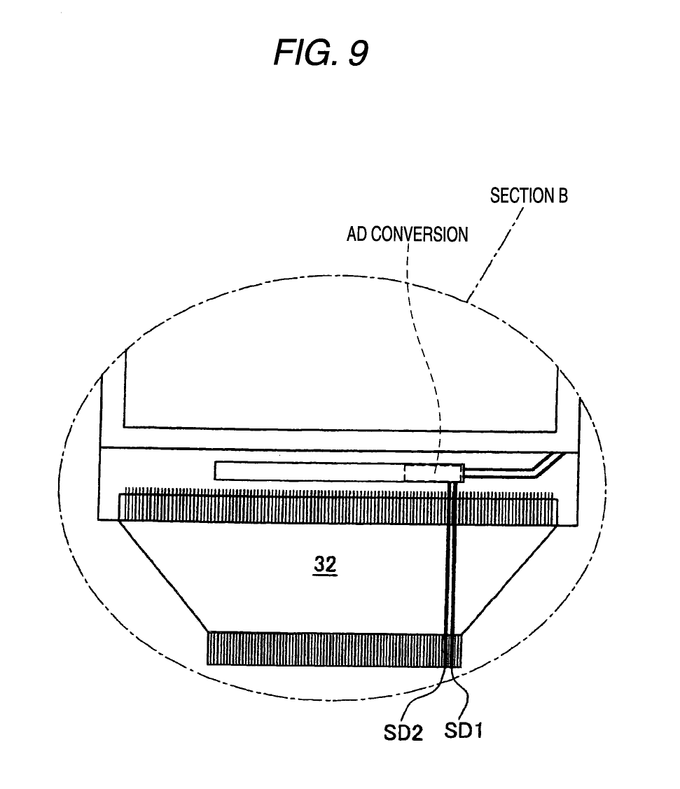

FIG. 9 is a view showing an example modification to the position where wiring is routed. In this example, the liquid-crystal driver 31 is equipped with an AD converter circuit; the signal output from the first sensor 7 by way of wiring and the signal output from the second sensor 8 by way of the same are digitized by means of the liquid-crystal driver 31; and digitized detection signals SD1 and SD2 are output.

FIG. 10 shows a block diagram pertaining to the entirety of a portable terminal including the liquid-crystal display device of the present invention; especially, the entirety of a portable cellular phone. A portable terminal 100 has a power section 101, a battery 102, a control section 103, a radio section 104, a display control section 105, the TFT liquid-crystal panel 2 (FIG. 1), a backlight control section (a booster section) 107, the backlight 5, a timer control section 109, a sound processing section 110, a speaker 111, a microphone 112, a key input section 113, a storage device 114, an AD conversion section 115. As a matter of course, the portable terminal is not limited to the portable cellular phone, and the present invention can also be applied to a portable terminal of another type, such as a PDA (Personal Digital Assistant) or the like.

The power section 101 controls activation or deactivation of power of the portable terminal 100, and includes a battery voltage detection section 1a for detecting the remaining amount of power in the battery 102. The battery 102 is usually formed from a few battery bars (cells).

The control section 103 is for controlling the entirety of the portable terminal 100; and comprises a CPU (Central Processing Unit) for controlling individual sections and performing various types of arithmetic operations in accordance with a predetermined program, data, or the like; RAM (Random Access Memory) for temporarily storing a program, data, and the like; ROM (Read-Only Memory) for accumulating a predetermined program and the like.

The radio section 104 is for transmitting and receiving radio waves by way of an antenna and formed from various radio circuits, a matching circuit, and the like.

The display control section 105 is for driving or controlling the TFT liquid-crystal panel 2 upon receipt of a command from the control section 103; and includes at least a portion of the drive circuit 3 including the liquid-crystal driver (an LSI for driving liquid crystal) 31 shown in FIG. 1. The liquid-crystal panel 2 has a configuration including the detection signal from the first sensor 7 shown in FIG. 5 and the second sensor 8; and detects external light and light from the backlight simultaneously with displaying of a predetermined image.

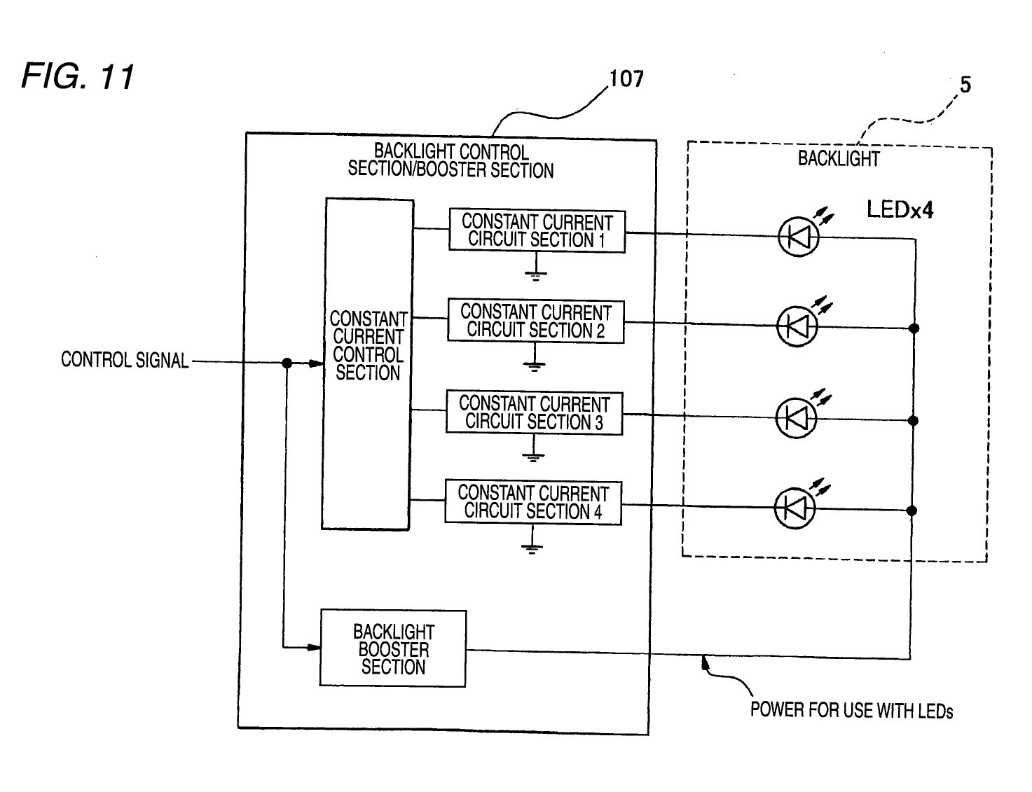

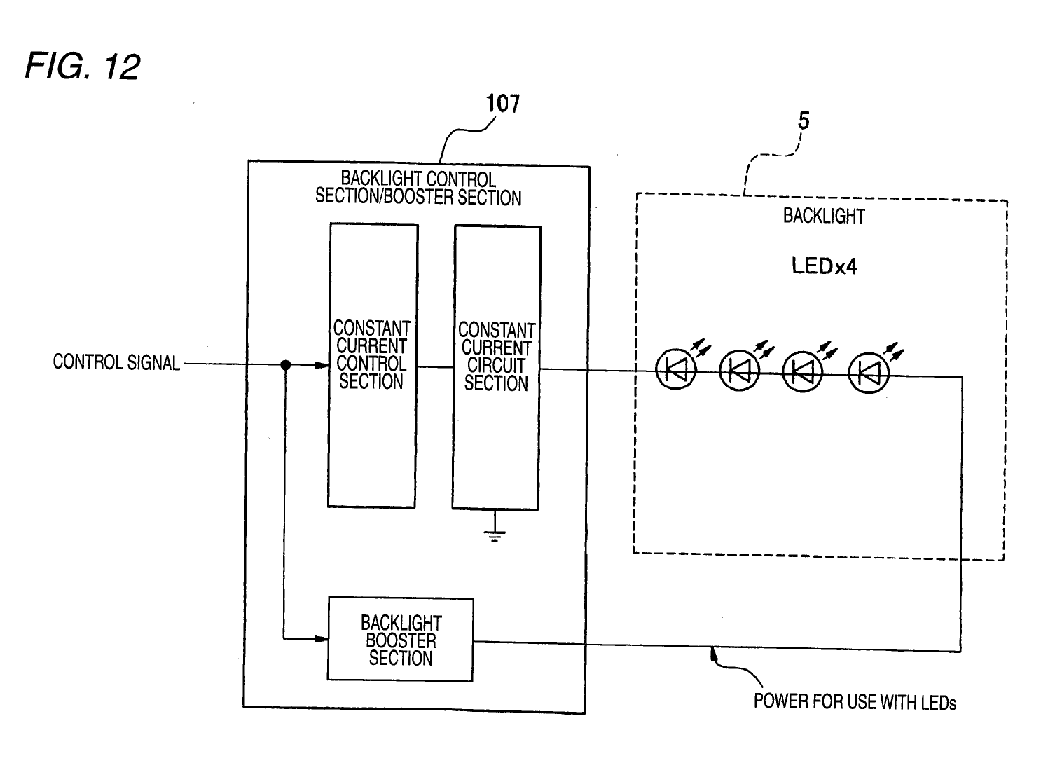

The backlight control section/booster section 107 is formed from a booster circuit for controlling the brightness of the backlight 5, an illumination area, and the like. FIGS. 11 and 12 show an example configuration of the backlight control section/booster section 107. When the light source of the backlight is formed from an LED (Light-Emitting Device), a method for driving the LED includes a method for driving parallel four LEDs shown in FIG. 11 and a method for driving serial four LEDs shown in FIG. 12. A constant-current control section is controlled by the control signal, and the constant-current circuit section can set an electric current to be flowed to the LEDs. In the case of four parallel LEDs, an electric current flowing into the respective LEDs can be controlled.

The backlight 5 includes a light-guiding plate and LEDs as the light source, and is usually placed behind the liquid-crystal display device 6. An ordinary light bulb rather than the LED can also be used for the light source. Moreover, when necessary, a reflection plate, a prism sheet, a diffuser panel, or the like, can be incorporated into the backlight.

The timer control section 109 performs driving of a timer built in the portable terminal 100, controlling of a timer, and the like. The sound processing section 110 receives from the control section 103 received radio waves or a command deriving from a predetermined function and converts the thus-received radio waves or command into sound information to be output from the speaker 111; and also converts external sound information picked up by the microphone 112 into a predetermined signal to be output to the control section 103. The key input section 113 is formed from various keys formed in a housing of the portable terminal 100, such as a cross-shaped key, a numeric ten-digit keypad, and the like. The storage device 114 is formed from nonvolatile memory, a compact HDD (Hard Disc Drive), or the like, and stores data such as an address and the like.

The AD conversion section 115 is a section for converting the analog detection signal from the first sensor 7 and the analog detection signal from the second sensor 8, both sensors belonging to the TFT liquid-crystal panel 2, into digital signals. However, in the example shown in FIG. 9, the AD conversion section 115 is built in the liquid-crystal driver; namely, the display control section 105, thereby obviating a necessity for additional provision of the AD conversion section 115. Hence, the detection signals are sent along a path such as that indicated by a dotted line.

The liquid-crystal display device is formed from the TFT liquid-crystal panel 2, the display control section 105, the control section 103, the backlight control section/booster section 107, and the backlight 5. Constituent elements of the control section 103, which correspond to the display control section 105 and the backlight control section/booster section 107, constitute a liquid-crystal display device. It may be the case where use of a mere term “control section” indicates only a corresponding section (a section for setting and computing the brightness of the backlight) of the control section 103 or a configuration embodied by addition, to the control section, of the backlight control section/booster section 107 (a section for setting a value, such as an electric current complying with the computed brightness of the backlight).

In relation to various patterns for controlling the electric current to the backlight 5, there will be described hereunder a first embodiment in which the control section 103 adjusts the electric current to the backlight 5 in accordance with the detection signal from the first sensor 7 and the detection signal from the second sensor 8; a second embodiment in which the predetermined illumination brightness of the backlight responsive to the intensity of external light detected by the first sensor 7 is changed to meet the user's preference; and a third embodiment in which the illumination brightness of the backlight is further changed in accordance with the user's preference.

### First Embodiment

Next, operation of the control section 103 in the portable terminal 100 for adjusting an electric current for the backlight 5 in accordance with the detection signal from the first sensor 7 and the detection signal from the second sensor 8 will be described.

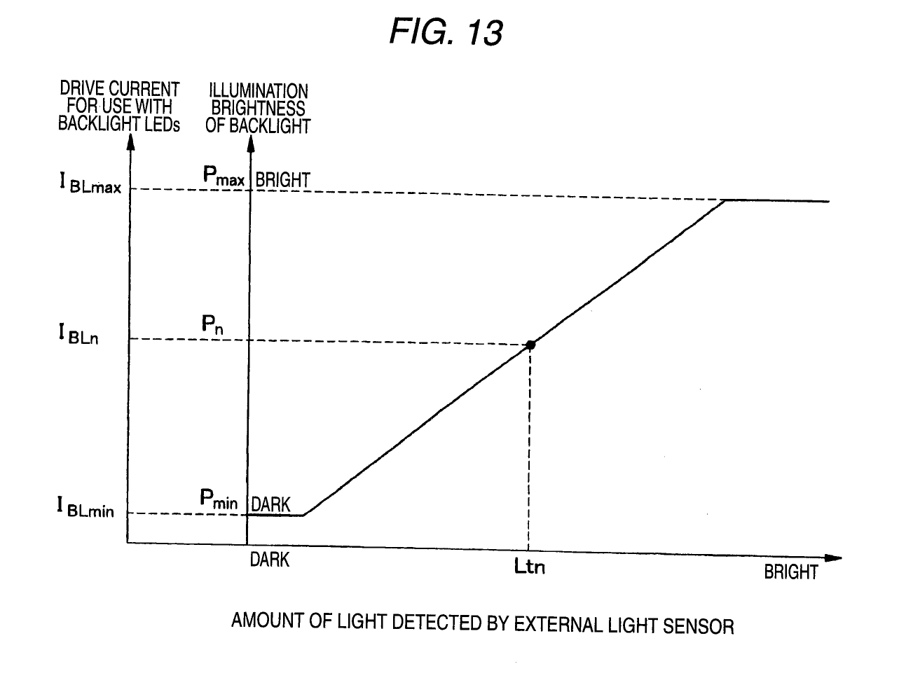

FIG. 13 shows a view showing the illumination brightness of the backlight 5 and a drive current for the backlight LEDs that are responsive to the quantity of light detected by the first sensor 7. As shown in FIG. 13, before correction operation is performed, the illumination brightness of the backlight 5 responsive to the quantity of light (the intensity of external light) detected by the first sensor 7 is determined beforehand. At the time of making of this determination, the minimum value of illumination brightness of the backlight 5 is set to optimum brightness at which visibility is ensured in a pitch dark environment and no glare arises; the illumination brightness of the backlight 5 is further set in such a way that an optimum appearance responsive to the intensity of external light is achieved; and a relationship between the intensity (the amount) of external light, the illumination brightness of the backlight, and a drive current for backlight LEDs is stored as a table in the storage device 114. Specifically, the table defines the brightness of the backlight optimum for the intensity of external light (a default value). Although the brightness of the backlight responsive to the intensity of external light is determined, a drive current for the backlight LEDs to achieve the backlight brightness is also previously determined as a default value. The default value is also stored as a table in the storage device 114, as in the case of the backlight brightness value.

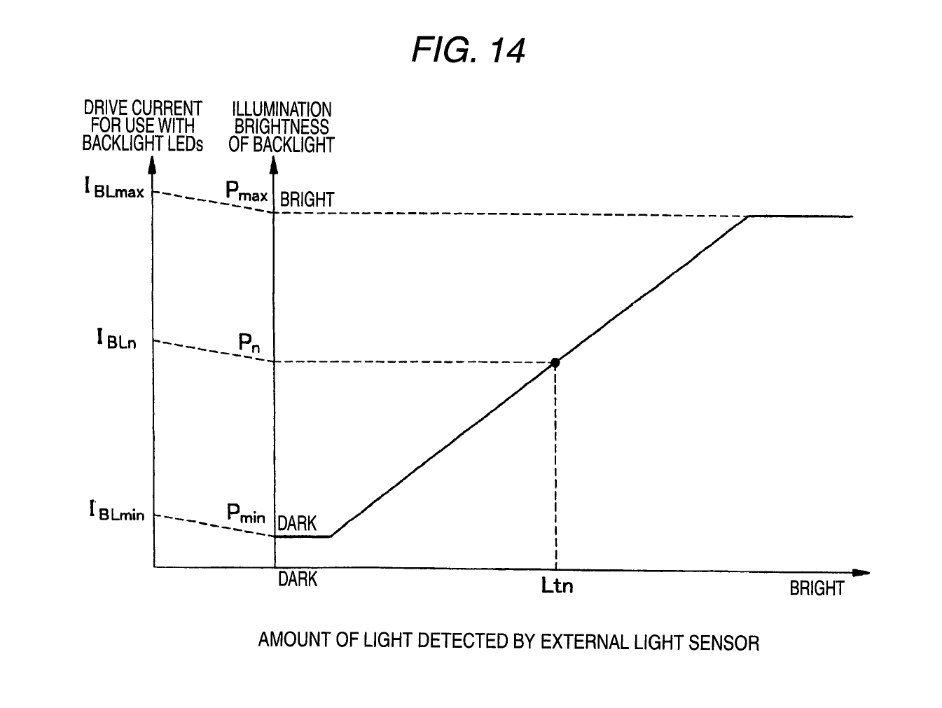

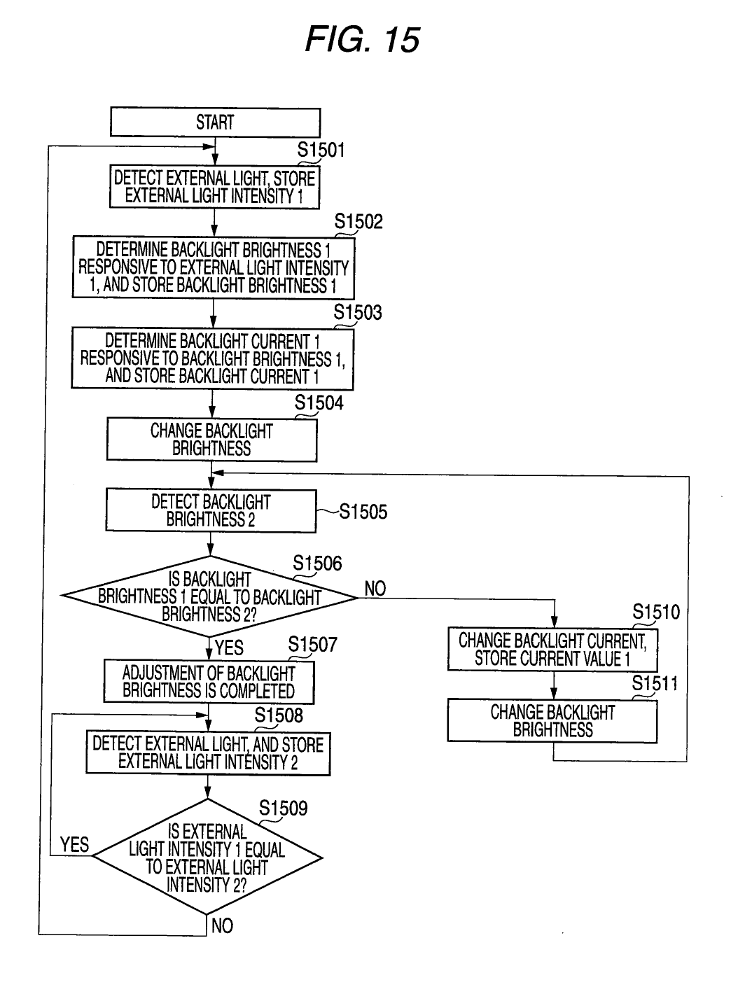

FIG. 14 shows an example where a correction is made to increase the drive current for the backlight LEDs when the brightness of backlight is lower than an optimum backlight brightness value when compared with the intensity of external light. Operation for making a correction to increase the drive current for the backlight LEDs shown in FIG. 14 will be described by reference to a flowchart shown in FIG. 15.

When the user activates the power of the portable terminal 100, the first sensor 7 detects external light, and the storage device 114 stores detected External Light Intensity 1 upon receipt of a control signal from the control section 103 (step S1501).

The control section 103 determines Backlight Brightness 1 responsive to External Light Intensity 1, and the storage device 114 stores the thus-determined Backlight Brightness 1 (step S1502). The control section 103 determines Backlight Brightness 1 responsive to External Light Intensity 1 from the illumination brightness of the backlight 5 at which an optimum appearance responsive to the intensity of external light stored in the storage device 114 is achieved.

The control section 103 further determines Backlight Current 1 responsive to Backlight Brightness 1, and the storage device 114 stores the thus-determined Backlight Current 1 (step S1503). The control section 103 determines Backlight Current 1 responsive to Backlight Brightness 1 from the drive current for the backlight LEDs that is stored in the storage device 114 for use in acquiring optimum backlight brightness.

Subsequently, the control section 103 changes the brightness of the backlight (step S1504). The control section 103 sets, in the backlight control section/booster section 107, a backlight current of Backlight Current 1 to which a reference has been made, by means of the control signal, thereby changing the brightness of the backlight.

The second sensor 8 subsequently detects Backlight Brightness 2, and outputs the thus-detected Backlight Brightness 2 to the control section 103 (step S1505). Upon receipt of this output, the control section 103 determines whether or not Backlight Brightness 1 is identical with Backlight Brightness 2 (step S1506). When Backlight Brightness 1 is determined to be identical with Backlight Brightness 2, adjustment of backlight brightness is completed (step S1507).

Further, the first sensor 7 again detects external light, and the storage section 114 stores detected External Light Intensity 2 upon receipt of the control signal from the control section 103 (step S1508).

Moreover, the control section 103 determines whether or not External Light Intensity 1 is identical with External Light Intensity 2, thereby determining whether or not changes exist in external light (step S1509). When in step S1509 External Light Intensity 1 is determined to be identical with External Light Intensity 2, the control section 103 deems that no changes exist in external light, and processing returns to step S1508, where external light is again detected by means of a sensor.

Meanwhile, when in step S1509 External Light Intensity 1 is determined not to be identical with External Light Intensity 2, the control section 103 deems that changes have arisen in external light, and processing returns to step S1501, where changed External Light Intensity 1 is detected.

When in step S1506 Backlight Brightness 1 is determined not to be identical with Backlight Brightness 2, the control section 103 changes the backlight current set in the backlight control section/booster section 107, and stores Backlight Current 1 into the storage device 114 (step S1510). In the case of the example shown in FIG. 14, since Backlight Brightness 2 is smaller than Backlight Brightness 1 optimum for the intensity of external light, Backlight Brightness 2 must be increased in order to achieve an optimum backlight brightness value. The control section 103 increases the drive current for the backlight LEDs.

The control section 103 changes the brightness of the backlight (step S1511), and processing returns to step S1505, where Backlight Brightness 2 is again detected by means of the sensor.

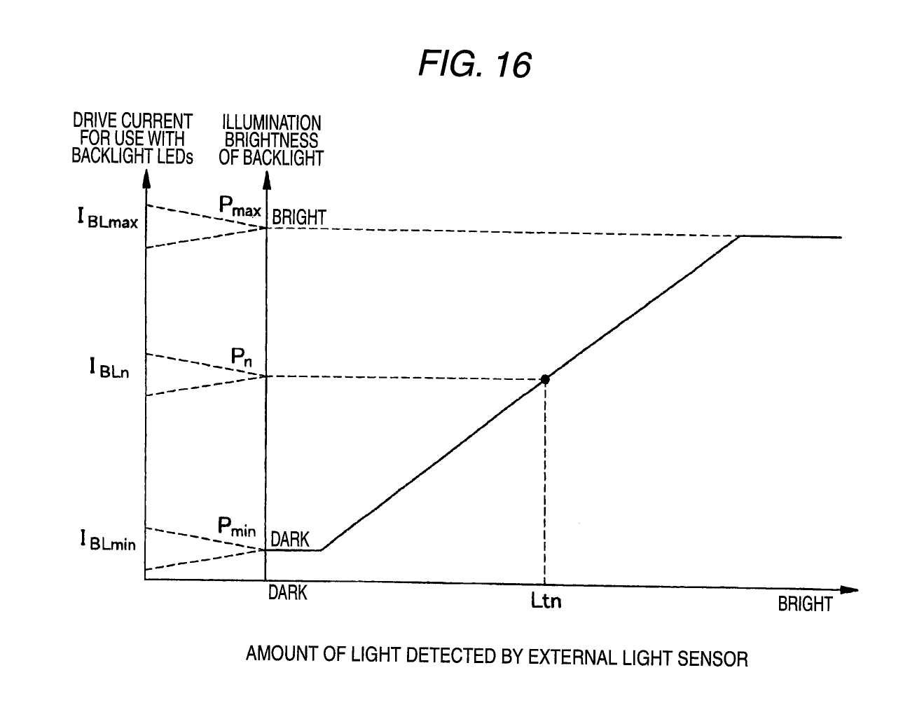

FIG. 16 shows an example where the drive current for the backlight LEDs is decreased when the brightness of the backlight is greater than the optimum backlight brightness value and where the drive current for the backlight LEDs is increased when the brightness of the backlight is smaller than the optimum backlight brightness value. Specifically, FIG. 16 is a view showing changes in the drive current for the backlight LEDs in response to variations in the brightness illumination of backlight.

In relation to the operation shown in FIG. 16 for making a correction to the variations in the brightness illumination of the backlight, when Backlight Brightness 2 is determined to be greater than optimum Backlight Brightness 1 with respect to the intensity of external light as a result of comparison between Backlight Brightness 1 and Backlight Brightness 2 in step S1510, Backlight Brightness 2 must be decreased in order to achieve the optimum backlight brightness value, and the drive current for the backlight LEDs is decreased.

In contrast, when Backlight Brightness 2 is smaller than optimum Backlight Brightness 1 with respect to the intensity of external light, Backlight Brightness 2 must be increased in order to achieve an optimum backlight brightness value, and the drive current for the backlight LEDs is increased. In other respects, processing is the same as correction operation shown in FIG. 14, and hence its explanation is omitted. Further, the table defining the illumination brightness of the backlight has a plurality of levels of steps and can be set freely. When more sophisticated adjustment of brightness is required, a setting is made to increase the number of steps, thereby realizing smooth changes.

According to such operation of the first embodiment for adjusting the current for the backlight 5 in accordance with the detection signal from the first sensor 7 and the detection signal from the second sensor 8, optimum brightness at which visibility is ensured in a pitch dark environment and a glare does not arise is set, whereby an optimum appearance responsive to the intensity of external light is obtained.

### SECOND EMBODIMENT

The present embodiment corresponds to an example where the predetermined illumination brightness of the backlight is changed, in accordance with the user's preference, with respect to the intensity of external light detected by the first sensor 7.

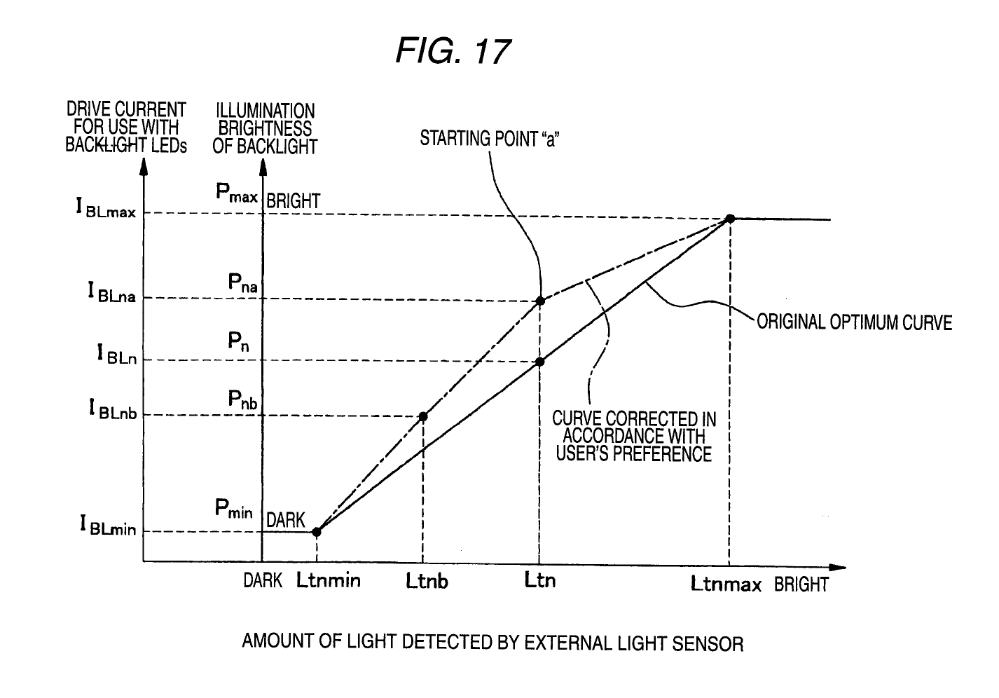

FIG. 17 shows an example where, when the user has changed settings of brightness of backlight from Pn to Pna while the intensity of external light is Ltn, IBLna responsive to backlight brightness Pna is caused to flow as a drive current for the backlight LEDs, thereby illuminating the LEDs. At this time, a point at which changes have been made is stored as a starting point “a.” A curve that connects the starting point “a” to the minimum value (Ltnmin) and the maximum value (Ltnmax) of an original optimum curve is taken as a curve corrected in accordance with the user's preference. For instance, when the intensity of external light has changed and the amount of light detected by the first sensor 7 has assumed Ltnb, IBLnb is caused to flow as backlight illumination brightness Pnb; that is, a drive current for the backlight LEDs, in accordance with the corrected curve, to thus illuminate the backlight.

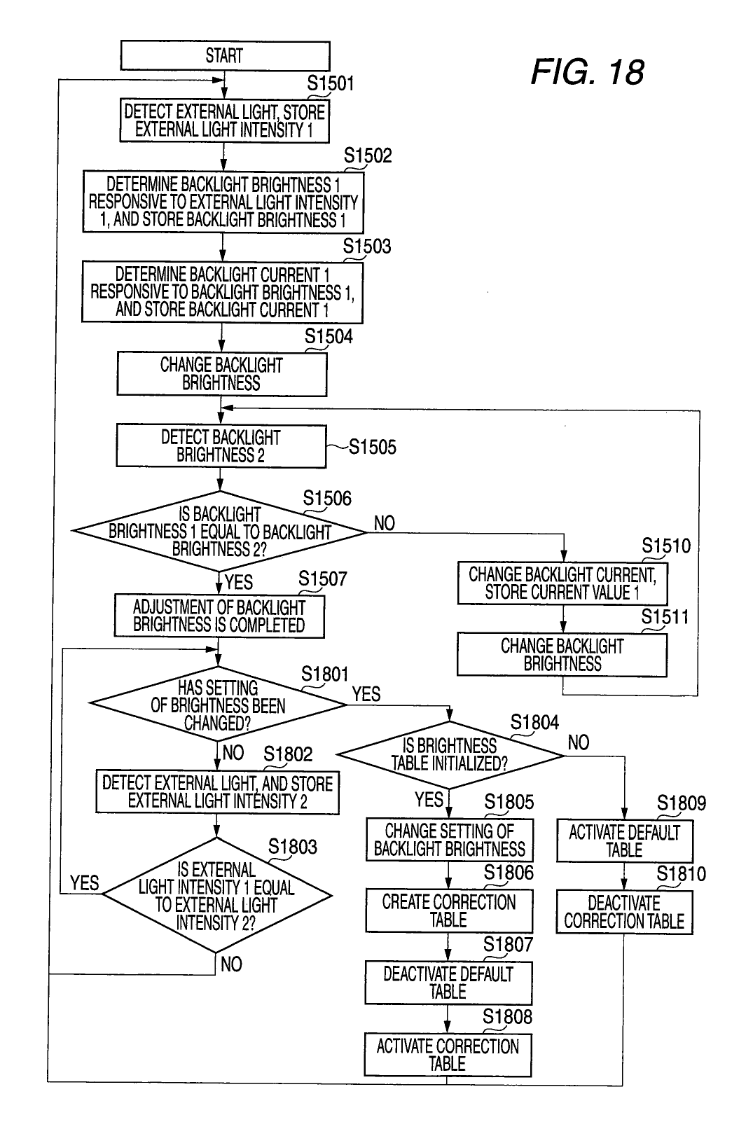

FIG. 18 is a view showing correction operation performed when the user has changed the setting.

In FIG. 18, operation up to operation for completing the adjustment of brightness of the backlight; i.e., procedures from step S1501 to step S1507, and operation for the case where Backlight Brightness 1 is not identical with Backlight Brightness 2; i.e., procedures step S1510 and S1511, are the same as those described in connection with the first embodiment shown in FIG. 15. Therefore, their explanations are omitted here.

After the adjustment of brightness of the backlight has been completed, the control section 103 determines, in response to the user's operation of the key input section 113 or the like, whether or not the setting of backlight brightness has been changed (step S1801). When the user's changes are determined not to have been made to the setting of backlight brightness, the first sensor 7 again detects external light. Upon receipt of the control signal from the control section 103, the storage device 114 stores detected External Light Intensity 2 (step S1802).

Further, the control section 103 determines whether or not External Light Intensity 1 is identical with External Light Intensity 2, thereby determining whether or not changes exist in external light (step S1803). When in step S1803 External Light Intensity 1 is determined to be identical with External Light Intensity 2, the control section 103 deems that no change exists in external light, and processing returns to step S1801, where a determination is again made as to whether or not the user has changed the setting of backlight brightness.

Meanwhile, when in step S1803 External Light Intensity 1 is determined to differ from External Light Intensity 2, the control section 103 deems that changes have arisen in external light, and processing returns to step S1501, where External Light Intensity 1 is detected.

When in step S1801 changes are determined to have been made to the setting of backlight brightness by the user, the control section 103 determines whether or not the backlight brightness table responsive to the intensity of external light stored in the storage device 114 is initialized (step S1804).

When in step S1804 the backlight brightness table responsive to the intensity of external light stored in the storage device 114 is determined to be initialized, the control section 103 activates the backlight brightness default table responsive to the intensity of external light (step S1809) and deactivates a backlight brightness correction table responsive to the intensity of external light (step S1810), and processing returns to step S1501.

Meanwhile, when in step S1804 the backlight brightness table responsive to the intensity of external light stored in the storage device 114 is determined not to be initialized, the control section 103 changes the setting of backlight brightness (step S1805) and creates a backlight brightness correction table which originates from a curve corrected in accordance with the user's preference and is responsive to the intensity of external light (step S1806). For instance, in the case of an example shown in FIG. 17, when the user has changed a setting of brightness of the backlight from Pn to Pna while the intensity of external light is Ltn, IBLna responsive to the backlight brightness Pna is set in the backlight control section/booster section 107 as a drive current for the backlight LEDs; and where the drive current is caused to flow into the LEDs, to thus illuminate the LEDs. The control section 103 creates (updates) a backlight brightness correction table while taking the thus-changed point Pna as the starting point “a,” and stores the thus-created backlight brightness correction table into the storage device 114. Subsequently, for example, when the amount of light detected by the first optical sensor 7 has assumed Ltnb as a result of a change having arisen in the intensity of external light, the illumination brightness of the backlight is changed to Pnb in accordance with the corrected curve; namely, IBLnb is caused to flow as a drive current for the backlight LEDs, thereby illuminating the LEDs.

The backlight brightness default table responsive to the intensity of external light is deactivated (step S1807), and the backlight brightness correction table responsive to the intensity of external light is activated (step S1808), and processing returns to step S1501.

As mentioned above, the illumination brightness of the backlight responsive to a change in external light is determined in accordance with the curve corrected so as to meet the user's preference, and the drive current for the backlight LEDs is caused to flow, so that optimum backlight brightness satisfying the user's preference can be achieved. Put another way, when the default value responsive to the predetermined intensity of external light has been changed to a new brightness level Pna or Pnb as indicated by starting point “a” or “b,” the control section 103 causes an electric current IBLna or IBLnb corresponding to such a new value to flow as a drive current into the light source LEDs. Moreover, the control section 103 sets a new default value (a new curve) over the entire intensity range (Ltnmin to Ltnmax) of external light in accordance with the newly-set starting point “a” or “b.”

### Third Embodiment

The present embodiment relates to an example where the illumination brightness of the backlight is further changed in accordance with the user's preference.

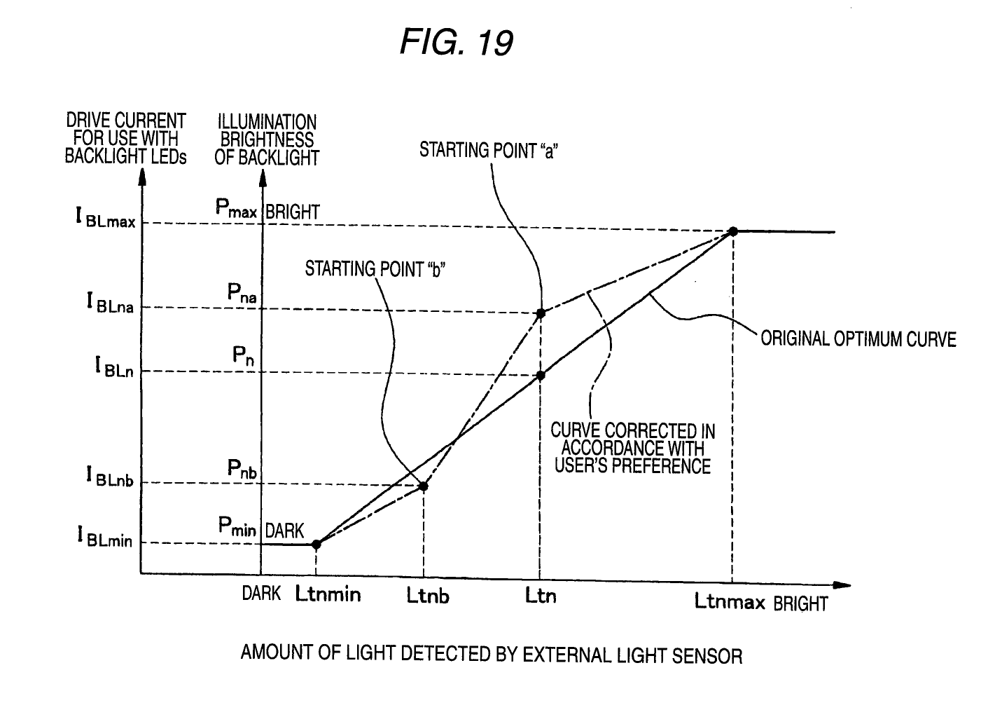

FIG. 19 shows an example where the user has changed settings of brightness of backlight from Pn to Pna while the intensity of external light is Ltn and subsequently further changed to Pnb the illumination brightness of backlight achieved while the intensity of the external light is Ltnb, thereby causing IBLnb to flow as a drive current for the backlight LEDs responsive to the brightness Pnb of backlight and illuminating the LEDs. Correction operation performed this time comprises, when processing again proceeds to step S1801 after processing pertaining to a step for changing the backlight brightness correction table shown in FIG. 18 has been performed, determining that the user has changed the brightness of the backlight (YES: step S1801); and in steps S1804 to 1806 creating and storing the backlight brightness correction table while the thus-changed point Pnb is taken as a starting point “b.” Now, a curve connecting the starting point “a” whose setting has been changed in the second embodiment to the starting point “b” whose setting has been changed in the present embodiment and another curve connecting the starting point “a” and the maximum value (Ltnmax) to the starting point “b” and the minimum value (Ltnmin) are taken as curves corrected in accordance with the user's preference. Subsequently, for instance, when the amount of light detected by the first optical sensor 7 has changed for reasons of occurrence of a change in the intensity of external light, the illumination brightness of the backlight; that is, the drive current for the backlight LEDs, is changed according to the thus-corrected curves. In other respects, the operation is the same as that described in connection with the second embodiment, and its explanation is omitted.

As above, the illumination brightness of the backlight responsive to the change in external light is determined in accordance with the curve further corrected in conformance to the use's preference, and the drive current for the backlight LEDs is caused to flow, so that optimum backlight brightness satisfying the user's preference can be acquired.

The above descriptions have mentioned the structure where the first optical sensor 7 and the second optical sensor 8 are each provided in the number of one. However, in order to prevent exertion of the influence of unevenness or a shade of partially-radiated light on external light and a decrease in accuracy of the backlight, which would otherwise be caused by variations in in-plane brightness of illumination (unevenness in illumination brightness), the first optical sensor 7 and the second optical sensor 8 can also be each provided in numbers.

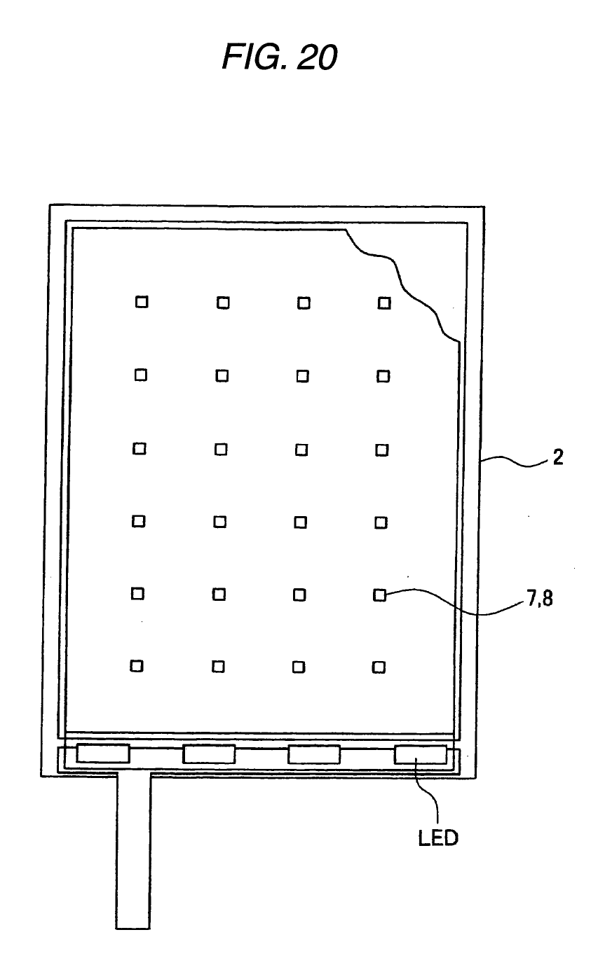

FIG. 20 shows an example where the first optical sensor 7 and the second optical sensor 8 are provided respectively in numbers. For example, in a case where detection is performed by use of one first optical sensor, when external light is not uniform and the sensor is disposed at a position in a shade, a detected value becomes smaller than a value of external light which should originally be detected, and illumination of low backlight brightness level is eventually performed. In contrast, when external light is not uniform and when the sensor is disposed at a position exposed to light, a detected value becomes greater than the value of external light that should originally be detected, and illumination of high backlight brightness level is eventually performed.

Moreover, in a case where detection is performed by use of one second optical sensor, when the sensor is disposed at a position where a low brightness level is achieved for reasons of variations in in-plane brightness of the backlight, a setting is made to a value which is greater than a backlight brightness setting value at which illumination should originally be effected. In contrast, when the sensor is disposed at a position where a high brightness level is achieved for reasons of variations in the in-plane brightness of the backlight, a setting is made to a value that is smaller than the backlight brightness setting value at which illumination should originally be effected. Occurrence of the above-mentioned mismatches can be prevented by means of arranging a plurality of sensors.

The manner in which the plurality of sensors are arranged is arbitrary. For instance, the first optical sensor 7 and the second optical sensor 8 can be provided for each of the pixels 40 or one of the sub-pixels 40R, 40G, and 40B shown in FIG. 7. Moreover, the number of the first optical sensors 7 may also be different from the number of the second optical sensors 8.

Although various embodiments of the present invention have been described thus far, the present invention is not limited to items described in connection with the embodiments. The present invention is expected to be altered or applied by the skilled in the art in accordance with the descriptions of the specification and known techniques, and the alterations or applications fall within a range in which protection is sought.

### INDUSTRIAL APPLICABILITY

As mentioned above, according to the liquid-crystal panel, the liquid-crystal display device, and the portable terminal of the present invention, miniaturization of the device can be realized while the brightness of the backlight is set optimally as required.

1-20. (canceled)

21. A liquid-crystal display device comprising:
a backlight;
a liquid-crystal panel provided on the backlight;
a first optical sensor for detecting external light and a second optical sensor for detecting brightness of the backlight which are provided in a plane of a glass substrate of the liquid-crystal panel; and
a control section for adjusting brightness of a light source of the backlight in accordance with intensity of external light detected by the first optical sensor and brightness of the backlight detected by the second optical sensor.

22. The liquid-crystal display device according to claim 21, wherein the first optical sensor is disposed in a display area where pixels of the liquid-crystal panel exist.

23. The liquid-crystal display device according to claim 22, wherein the first optical sensor is disposed at a position within a plane of the glass substrate spaced a predetermined distance away from a perimeter of the glass substrate.

24. The liquid-crystal display device according to claim 21, wherein the first optical sensor is positioned in an area in the plane of the liquid-crystal panel where a metallic wiring layer exists and on a side on which external light is incident when viewed from the metallic wiring layer.

25. The liquid-crystal display device according to claim 21, wherein the second optical sensor is positioned in an area within the plane of the liquid-crystal panel where a black matrix exists and on the backlight side when viewed from the black matrix.

26. The liquid-crystal display device according to claim 25, wherein the first optical sensor is disposed at an area within a plane of the liquid-crystal panel where the black matrix does not exist.

27. The liquid-crystal display device according to claim 21, wherein each of the first optical sensor and the second optical sensor is provided in numbers.

28. The liquid-crystal display device according to claim 21, further comprising:
a storage device for storing the brightness of the backlight previously set as a default value in response to the intensity of external light, wherein
the control section increases the brightness of a light source of the backlight when current brightness of the backlight is smaller than the default value responsive to predetermined intensity of external light.

29. The liquid-crystal display device according to claim 21, further comprising:
a storage device for storing the brightness of the backlight previously set as a default value in response to the intensity of external light, wherein
the control section decreases the brightness of a light source of the backlight when current brightness of the backlight is greater than the default value responsive to predetermined intensity of external light.

30. The liquid-crystal display device according to claim 21, further comprising:
a storage device for storing the brightness of the backlight previously set as a default value in response to the intensity of external light; and
an input section by means of which a user performs operation for changing backlight brightness of the backlight, wherein the control section sets the brightness of the light source in response to another value of backlight brightness when the brightness of the backlight has been changed, by means of the input section, to the other value from the default value responsive to the predetermined intensity of external light.

31. The liquid-crystal display device according to claim 30, wherein the control section sets a new default value over entire intensity range of external light in accordance with the other value.

32. A portable terminal comprising the liquid-crystal display device according to claim 21.

33. A liquid-crystal panel comprising:
a first glass substrate disposed at a side on which external light is incident;
a second glass substrate disposed at a side away from the side on which external light is incident, with respect to the first glass substrate;
a liquid-crystal layer sealed between the first glass substrate and the second glass substrate;
a first optical sensor which is disposed on either the first glass substrate or the second glass substrate for detecting external light; and
a second optical sensor which is disposed on either the first glass substrate or the second glass substrate for detecting brightness of a backlight, wherein
the first optical sensor is disposed on a first shield which blocks light from the backlight; and
the second optical sensor is disposed on a second shield which blocks external light.

34. The liquid-crystal panel according to claim 33, wherein the first optical sensor is disposed in a display area where pixels of the liquid-crystal panel exists.

35. The liquid-crystal panel according to claim 34, wherein the first optical sensor is disposed at a position within a plane spaced a predetermined distance or more away from a perimeter of the first glass substrate or the second glass substrate.

36. The liquid-crystal panel according to claim 33, wherein the first shield is a metallic wiring layer.

37. The liquid-crystal panel according to claim 33, wherein the second shield is a black matrix or a metallic wiring layer.

38. The liquid-crystal panel according to claim 37, wherein the first optical sensor is disposed at an area where the black matrix does not exist.

39. The liquid-crystal panel according to claim 38, wherein each of the first optical sensor and the second optical sensor is provided in numbers.

40. A portable terminal including the liquid-crystal panel of claim 33.
